(19) United States
(12) Patent Application Publication
(10) Pub. No.: US 2025/0175712 A1
(43) Pub. Date: May 29, 2025

(54) IMAGE PROCESSING METHOD AND APPARATUS, ELECTRONIC DEVICE, AND STORAGE MEDIUM

(71) Applicant: Beijing Zitiao Network Technology Co., Ltd., Beijing (CN)

(72) Inventor: Guang ZENG, Beijing (CN)

(21) Appl. No.: 18/725,587

(22) PCT Filed: Dec. 27, 2022
(86) PCT No.: PCT/CN2022/142226

§ 371 Date: Jun. 28, 2024

(30) Foreign Application Priority Data
Dec. 28, 2021 (CN) 202111622433.7

(51) Int. Cl. H04N 23/88; H04N 9/73

(52) U.S. Cl. CPC H04N 23/88; H04N 9/73

(57) ABSTRACT

An image processing method and apparatus, an electronic device and a storage medium. The method comprises: in response to receiving a first color adjustment instruction, processing a preset image on the basis of a first color adjustment algorithm which matches the first color adjustment instruction so as to obtain a first image, wherein mapped color values obtained from the preset image on the basis of input color values are the same as the input color values; mapping color values in the first image to an original image to be processed to obtain a mapped original image in such a way that the mapped original image presents a color effect that matches the first color adjustment instruction.

### CROSS-REFERENCE TO RELATED APPLICATIONS

This application claims the benefit of priority to the Chinese patent application No. 202111622433.7, entitled “IMAGE PROCESSING METHODS AND APPARATUS, ELECTRONIC DEVICES, AND STORAGE MEDIA”, filed on Dec. 28, 2021, which is hereby incorporated by reference in its entirety into the present application.

### TECHNICAL FIELD

This disclosure relates to the field of information technology, particularly to an image processing method and apparatus, an electronic device, and a storage medium.

### BACKGROUND

With the rapid development of terminal device technology, the number of pixels for mainstream cameras is now over 12 million, which means that the image resolution achieved by the cameras is at least 3000*4000. On the other hand, current image post-processing (such as image retouching) usually supports at least two processing functions, such as adjustment of image brightness, contrast, color temperature, or saturation.

In related art, when multiple processes are applied to an original image, these processes are sequentially “stacked” on the original image. For example, when a user triggers a brightness adjustment control, the brightness of the original image is adjusted using a brightness adjustment algorithm to obtain an intermediate image; if the user then triggers a contrast adjustment control, the contrast of the intermediate image is adjusted using a contrast adjustment algorithm. In other words, each process directly affects each pixel point in the original image. Therefore, when a user performs multiple processes on an original image (such as adjusting the brightness and contrast of the image concurrently), the implementations of related art suffer from a problem of great amount of computation.

### SUMMARY

Embodiments of the present disclosure provide an image processing method and apparatus, an electronic device, and a storage medium.

In a first aspect, embodiments of the present disclosure provide an image processing method, comprising:
in response to receiving a first color adjustment instruction, processing a preset image based on a first color adjustment algorithm matching the first color adjustment instruction to obtain a first image, wherein mapped color values obtained from the preset image based on input color values are the same as the input color values;
mapping color values in the first image to an original image to be processed in such a way that the original image presents a color effect that matches the first color adjustment instruction, the total number of pixel points in the preset image being less than the total number of pixel points in the original image.

In a second aspect, embodiments of the present disclosure provide an image processing apparatus, comprising:
a first processing module configured to, in response to receiving a first color adjustment instruction, process a preset image based on a first color adjustment algorithm matching the first color adjustment instruction to obtain a first image, wherein mapped color values obtained from the preset image based on input color values are the same as the input color values;
a second processing module configured to map color values in the first image to an original image to be processed in such a way that the original image presents a color effect that matches the first color adjustment instruction, the total number of pixel points in the preset image being less than the total number of pixel points in the original image.

In a third aspect, embodiments of the present disclosure provide an electronic device, comprising:
one or more processors;
a storage device for storing one or more programs that,
when executed by the one or more processors, cause the one or more processors to implement the above image processing method.

In a fourth aspect, embodiments of the present disclosure further provide a computer readable storage medium stored thereon a computer program that, when executed by a processor, implements the image processing method described above.

In a fifth aspect, embodiments of the present disclosure further provide a computer program product, including a computer program that, when executed by a processor, implements the image processing method described above.

In a sixth aspect, embodiments of the present disclosure further provide a computer program including a computer instructions that, when executed by a processor, implement the image processing method described above.

### BRIEF DESCRIPTION OF THE DRAWINGS

The above and other features, advantages, and aspects of the embodiments of the present disclosure will become more apparent from the following embodiments with reference to the drawings. Throughout the drawings, the same or similar reference signs indicate the same or similar elements. It should be understood that the drawings are schematic and the components and elements are not necessarily drawn to scale.

FIG. 1 is a flowchart of an image processing method provided by embodiments of the present disclosure;

FIG. 2 is a schematic structural diagram of an image processing apparatus provided by embodiments of the present disclosure;

FIG. 3 is a schematic structural diagram of an electronic device provided by embodiments of the present disclosure.

### DETAILED DESCRIPTION

Exemplary embodiments of the present disclosure will now be described in detail with reference to the accompanying drawings. Although some embodiments of the present disclosure are shown, it should be understood that the present disclosure can be implemented in various forms, and should not be construed as being limited to the embodiments set forth herein. On the contrary, these embodiments are provided for a more thorough and complete understanding of the present disclosure. It should be understood that the drawings and embodiments of the present disclosure are only used for exemplary purposes, and are not used to limit the scope of protection of the present disclosure.

It should be understood that the various steps described in the methods of the embodiments of the present disclosure may be executed in a different order, and/or executed in parallel. In addition, the methods may include additional steps and/or some of the illustrated steps may be omitted. The scope of this disclosure is not limited in this regard.

The term “including” and its variants as used herein is non-exclusive, that is, “including but not limited to”. The term “based on” means “based at least in part on”. The term “one embodiment” means “at least one embodiment”; The term “another embodiment” means “at least one additional embodiment”; The term “some embodiments” means “at least some embodiments”. Related definitions of other terms will be given in the following description.

It should be noted that the concepts of “first” and “second” mentioned in the present disclosure are only used to distinguish different devices, modules or units, and are not used to limit the order of functions performed by these devices, modules or units, or interdependence therebetween.

It should be noted that the modifications of “a” and “a plurality of” mentioned in the present disclosure are illustrative and not restrictive, and those skilled in the art should understand that unless otherwise clearly indicated in the context, they should be understood as “one or more”.

The names of messages or information exchanged between multiple devices in the embodiments of the present disclosure are only used for illustrative purposes, and are not used to limit the scope of these messages or information.

Embodiments of the present disclosure can achieve the purpose of processing an original image by means of a preset image, which can achieve the effect of reducing the amount of processing computation.

The technical solutions provided in the embodiments of the present disclosure have at least the following advantages: in the image processing method provided in embodiments of the present disclosure, a preset image is used as an intermediate medium which is first processed based on color adjustment algorithms that match a plurality of color adjustment instructions respectively to obtain a preset image to which a plurality of color effects are applied; and then the color effects on the preset image are applied to the original image based on a mapping relationship between the preset image and the original image, which is equivalent to applying only one color adjustment process on the original image. Since the total number of pixel points in the preset image is smaller than the total number of pixel points in the original image, it can reduce the amount of computation generated during color adjustment and improve image processing efficiency.

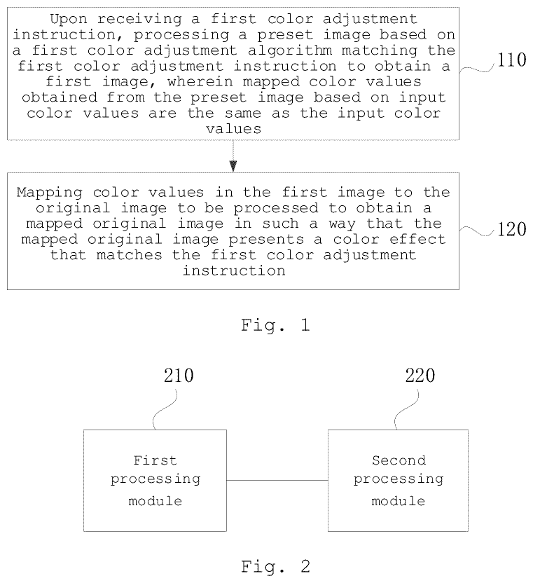

FIG. 1 is a flowchart of an image processing method provided by embodiments of the present disclosure. This method can be performed by an image processing apparatus, which can be implemented in software and/or hardware. The apparatus can be configured in electronic devices, such as display terminals, including but not limited to smartphones, handheld computers, tablets, portable and wearable devices, smart home devices (such as desk lamps), and other electronic devices with display screens.

As shown in FIG. 1, the method may particularly comprise the following steps.

In step 110, in response to receiving a first color adjustment instruction, a preset image is processed based on a first color adjustment algorithm matching the first color adjustment instruction to obtain a first image, wherein mapped color values obtained from the preset image based on input color values are the same as the input color values.

The limitation that mapped color values obtained from the preset image based on input color values are the same as the input color values can ensure that the preset image is an image without any color effect applied. This preset image can be used as an intermediate medium to first apply a specified color effect to the preset image, and then apply the color effect to the original image to be processed based on the mapping relationship.

In step 120, color values in the first image are mapped to the original image to be processed in such a way that the original image presents a color effect that matches the first color adjustment instruction, the total number of pixel points in the preset image being less than the total number of pixel points in the original image.

Since the total number of pixel points in the preset image is less than the total number of pixel points in the original image, processing the preset image using a first color adjustment algorithm matching the first color adjustment instruction can achieve a reduction in processing complexity compared to directly processing the original image using the first color adjustment algorithm.

Current mainstream cameras generally have over 12 million pixels, which means that the image resolution achieved by the cameras is at least 3000*4000. When color adjustment is performed on an original image to be processed, it is necessary to calculate separately for each pixel point in the original image. Due to the large number of pixels, there are many pixel points in the original image. Therefore, when multiple types of color adjustments are applied to the original image (such as adjustments to image brightness, contrast, color temperature, etc.), if these adjustments are applied directly to each pixel point in the original image, it will generate a large amount of computation. Based on this, in the technical solution of embodiments of the present disclosure, a preset image having fewer pixel points is used as an intermediate image to which multiple color adjustment effects are applied separately, and then the color adjustment effects of the preset image are applied to the original image by utilizing the mapping relationship between the color values of pixel points in the original image and the color values in the preset image, thereby achieving multiple color adjustment effects on the original image.

Furthermore, before mapping color values in the first image to the original image to be processed, the method further comprises: in response to receiving a second color adjustment instruction, processing the first image based on a second color adjustment algorithm matching the second color adjustment instruction to obtain a second image; mapping color values in the first image to the original image to be processed comprises: mapping color values in the second image to the original image in such a way that the original image presents color effects that match the first color adjustment instruction and the second color adjustment instruction, respectively.

Suppose the resolution of the original image to be processed is 3000*4000, which means there are 3000*4000 pixel points in the original image. For example, if 10 color adjustments are applied to the original image, and each color adjustment is applied directly to the original image, the resulting amount of computation is 3000*4000*10. If the 10 color adjustments are first applied to the preset image (assuming the resolution of the preset image is 512*512), and then the color adjustment effects of the preset image are imposed to the original image, the resulting amount of computation is 512*512*10+3000*4000. The ratio of amounts of computation between these two processing methods is approximately 8.2:1, indicating that the amount of computation caused by these color adjustments can be greatly reduced by transferring effects from the preset image.

Optionally, the preset image comprises a color lookup table (LUT). This LUT (Lookup table) essentially represents a color mapping relationship. Based on an input color value, a position corresponding to this input color value on the LUT image can be determined, and a processed color value at this corresponding position can be used as a color value corresponding to the input color value. Therefore, for the color value of each pixel point in the original image to be processed, a corresponding color value can be found on the LUT image.

Particularly, a standard LUT image must be created in such a way that a mapped color value obtained from the standard LUT image is the same as the input color value, i.e. no color effects are added to the standard LUT image. The standard LUT image is defined as the preset image. In summary, the mapped color value obtained from the preset image based on the input color value is the same as the input color value. For example, if the input color value is RGB (0,0,0), the mapped color value obtained from the preset image is also RGB (0,0,0).

The size of the preset image can be set according to actual needs. It can be understood that if the size of the preset image is too large, there will be no significant improvement in reducing the amount of computation; if the size of the preset image is too small, the processing accuracy may not meet the requirements. Through several business experiments, a size of 515*512 is selected, which can achieve good overall performance (which can meet the requirements of reducing the amount of computation and the requirements of accuracy).

Taking a preset image in a size of 515*512 as an example, the range of values for each color component R, G, and B in the color value is 0-255. “//” represents integer division, for example, 6/4=1, “%” represents taking a remainder, for example, 6% 4=2. (x, y) represents the coordinates of a pixel point in the preset image. The correspondence between a color value and the coordinates in the preset image is:

$$x = ( B // 4 \% 8 ) * 64 + R // 4$$

$$y = ( B // 4 // 8 ) * 64 + G // 4$$

Based on the above correspondence, a color value can be obtained for each coordinate position in the preset image. For example, the color value RGB (8, 8, 32) corresponds to coordinates (2, 66) in the preset image, that is, the color value at the position (2, 66) in the preset image is (8, 8, 32). The range of values for the R, G and B components is 0-255. By traversing all the color values, pixel values that correspond to all the coordinate positions in the preset image can be obtained.

For example, the first color adjustment instruction can specifically be a contrast adjustment instruction, a color temperature adjustment instruction, or a brightness adjustment instruction.

In response to receiving the first color adjustment instruction, each color value in the preset image is processed based on a first color adjustment algorithm matching the first color adjustment instruction, so that the preset image presents a color effect corresponding to the first color adjustment instruction. The preset image that presents a color effect corresponding to the first color adjustment instruction is defined as the first image. Specifically, with the preset image as an intermediate medium, the preset image is first processed based on a first color adjustment algorithm matching the first color adjustment instruction to obtain a first image with a color effect applied. Then, the color effect on the first image is applied to the original image to be processed. Specifically, the color values in the first image are mapped to the original image to be processed in such a way that the original image presents a color effect that matches the first color adjustment instruction.

In some embodiments, mapping color values in the first image to the original image to be processed comprises:
based on the color value of each pixel point in the original image, determining a mapped coordinate of the pixel point in the first image; determining a mapped color value of each pixel point based on the mapped coordinate of the pixel point in the first image; for each pixel point in the original image, replacing the color value of the current pixel point with the mapped color value of the current pixel point.

Wherein, based on the color value of each pixel point in the original image, determining a mapped coordinate of the pixel point in the first image comprises:
based on a color value of a current pixel point, determining a first mapped coordinate of the pixel point in the first image using a first conversion rule, the current pixel point being any pixel point in the original image.

Wherein, the first conversion rule is determined based on the size of the preset image. Taking a preset image with a size of 512*512 as an example, the first conversion rule is:

$$x 1 = ( B // 4 \% 8 ) * 64 + R // 4$$

$$y 1 = ( B // 4 // 8 ) * 64 + G // 4$$

For example, if the color value of a current pixel point is RGB (8, 8, 32), the first mapped coordinate of the current pixel point in the first image is (2, 66). The color value at the coordinate (2, 66) in the first image is the mapped color value of the current pixel point. Assuming that the color value at the coordinate (2, 66) in the first image is RGB (32, 16, 5), the color value of the current pixel point will be changed from RGB (8, 8, 32) to RGB (32, 16, 5). The color values of all pixel points in the original image are replaced in the above manner, and then an original image with a color effect can be obtained.

It can be understood that the coordinates determined based on the first conversion rule described above may not be integers but decimals, that is, the determined mapped coordinate may fall between two pixel points. In this case, the mapped color value corresponding to the mapped coordinate can be determined by interpolation to improve the accuracy of determining the mapped color value, thereby improving the image processing effect.

For example, for each pixel point in the original image, determining a mapped color value of the pixel point based on the mapped coordinate of the pixel point in the first image comprises:

in a case where there is a pixel point at the first mapped coordinate in the first image, the color value of the pixel point at the first mapped coordinate in the first image is determined as the mapped color value of the current pixel point; in a case where there is no pixel point at the first mapped coordinate in the first image, determining the mapped color value of the current pixel point by interpolation.

Determining the mapped color value of the current pixel point by interpolation comprises:
determining a second mapped coordinate of the current pixel point in the first image based on its color value using a second conversion rule; determining a first color value corresponding to the first mapped coordinate and a second color value corresponding to the second mapped coordinate respectively; determining a mapped color value of the current pixel point based on the first color value and the second color value.

Wherein, the second conversion rule may be:

$$x 2 = ( ( B // 4 + 1 ) \%8 ) * 64 + R // 4$$

$$y 2 = ( ( B // 4 + 1 ) // 8 ) * 64 + G // 4$$

Optionally, determining a mapped color value of the current pixel point based on the first color value and the second color value comprises: taking a weighted sum of the first color value and the second color value to obtain the mapped color value of the current pixel point; or determining an average of the first color value and the second color value as the mapped color value.

Specifically, the weight values used in taking the weighted sum of the first color value and the second color value can be determined based on the value of the blue component in the color value of the current pixel point. Wherein, fract( ) returns the decimal part of a number, for example, fract(10.32)=0.32; the weight value w=fract(B/4), wherein color (x, y) represents the color value of the LUT image at the coordinate position (x, y); the first color value is defined as c1=color (x1, y1), the second color value is defined as c2=color (x2, y2), and the mapped color value of the current pixel point c=w*c1+(1−w)*c2.

Furthermore, in some optional embodiments, before mapping color values in the first image to the original image to be processed, the method further comprises:
in response to receiving a second color adjustment instruction, processing the first image based on a second color adjustment algorithm matching the second color adjustment instruction to obtain a second image; mapping color values in the first image to the original image to be processed comprises: mapping color values in the second image to the original image in such a way that the original image presents color effects that match the first color adjustment instruction and the second color adjustment instruction, respectively.

That is, the color effects corresponding to multiple color adjustment instructions are first applied to the preset image. Then, based on the preset image to which multiple color effects are applied, mapped color values corresponding to various color values in the original image are obtained. Then, the original color values are replaced with the mapped color values to obtain the original image that presents the color adjustment effects. In other words, only one color adjustment is performed on the original image. Suppose the resolution of the original image to be processed is 3000*4000, which means there are 3000*4000 pixel points in the original image. For example, if 10 color adjustments are applied to the original image, and each color adjustment is applied directly to the original image, the resulting amount of computation is 3000*4000*10. If the 10 color adjustments are first applied to the preset image (assuming the resolution of the preset image is 512*512), and then the color adjustment effects of the preset image are imposed to the original image, the resulting amount of computation is 512*512*10+3000*4000. The ratio of amounts of computation between these two processing methods is approximately 8.2:1, indicating that the amount of computation caused by these color adjustments can be greatly reduced by transferring effects from the preset image.

Moreover, in the technical solution of this embodiment, there is no need to modify the existing color adjustment algorithms. Instead of the original image to be processed, the object of the color adjustment algorithm is replaced by a preset image. Finally, the color effects in the preset image are applied to the original image through the mapping relationship between the preset image and the original image, thereby achieving the goal of reducing the amount of computation and improving processing efficiency.

In the image processing method provided in embodiments of the present disclosure, a preset image is used as an intermediate medium which is first processed based on color adjustment algorithms matching a plurality of color adjustment instructions respectively to obtain a preset image to which a plurality of color effects are applied; and then the color effects on the preset image are applied to the original image based on a mapping relationship between the preset image and the original image, which is equivalent to applying only one color adjustment process on the original image. Since the number of pixel points in the preset image is smaller than the number of pixel points in the original image, it can greatly reduce the amount of computation generated during color adjustment and improve image processing efficiency.

FIG. 2 is a schematic structural diagram of an image processing apparatus provided by embodiments of the present disclosure. As shown in FIG. 2, the image processing apparatus specifically comprises: a first processing module 210 and a second processing module 220.

Wherein, the first processing module 210 is configured to, in response to receiving a first color adjustment instruction, process a preset image based on a first color adjustment algorithm matching the first color adjustment instruction to obtain a first image, wherein mapped color values obtained from the preset image based on input color values are the same as the input color values; the second processing module 220 is configured to map color values in the first image to an original image to be processed in such a way that the original image presents a color effect matching the first color adjustment instruction, the total number of pixel points in the preset image being less than the total number of pixel points in the original image.

Optionally, the apparatus further comprises: a third processing module configured to, prior to mapping color values in the first image to the original image to be processed, in response to receiving a second color adjustment instruction, process the first image based on a second color adjustment algorithm matching the second color adjustment instruction to obtain a second image. Accordingly, the second processing module 220 is configured to: map color values in the second image to the original image in such a way that the original image presents color effects that match the first color adjustment instruction and the second color adjustment instruction, respectively.

Optionally, the preset image comprises a color lookup table (LUT).

Optionally, the second processing module 220 comprises: a first determination unit configured to, based on the color value of each pixel point in the original image, determine a mapped coordinate of the pixel point in the first image; a second determination unit configured to determine a mapped color value of each pixel point based on the mapped coordinate of the pixel point in the first image; a generation unit configured to replace, for each pixel point in the original image, the color value of a current pixel point with the mapped color value of the current pixel point.

Optionally, the first determination unit is particularly configured to: based on the color value of a current pixel point, determine a first mapped coordinate of the pixel point in the first image using a first conversion rule, the current pixel point being any pixel point in the original image.

Optionally, the second determination unit is particularly configured to: in a case where there is a pixel point at the first mapped coordinate in the first image, determine the color value of the pixel point at the first mapped coordinate in the first image as the mapped color value of the current pixel point; in a case where there is no pixel point at the first mapped coordinate in the first image, determine the mapped color value of the current pixel point by interpolation.

Optionally, the second determination unit comprises: a first determination subunit for determining a second mapped coordinate of the current pixel point in the first image based on the color value of the current pixel point using a second conversion rule; a second determination subunit for determining a first color value corresponding to the first mapped coordinate and a second color value corresponding to the second mapped coordinate respectively; a third determination subunit for determining a mapped color value of the current pixel point based on the first color value and the second color value.

Optionally, the third determination subunit is specifically configured to: take a weighted sum of the first color value and the second color value to obtain the mapped color value of the current pixel point.

In the image processing apparatus provided in embodiments of the present disclosure, a preset: image is used as an intermediate medium which is first processed based on color adjustment algorithms that matches a plurality of color adjustment instructions respectively to obtain a preset image to which a plurality of color effects are applied; and then the color effects on the preset image are applied to the original image based on a mapping relationship between the preset image and the original image, which is equivalent to applying only one color adjustment process on the original image. Since the number of pixel points in the preset image is smaller than the number of pixel points in the original image, it can greatly reduce the amount of computation generated during color adjustment and improve image processing efficiency.

The image processing apparatus provided in this embodiment can execute the steps of the image processing method provided in embodiments of the present disclosure. The steps involved and the beneficial effect achieved will not be repeated in detail.

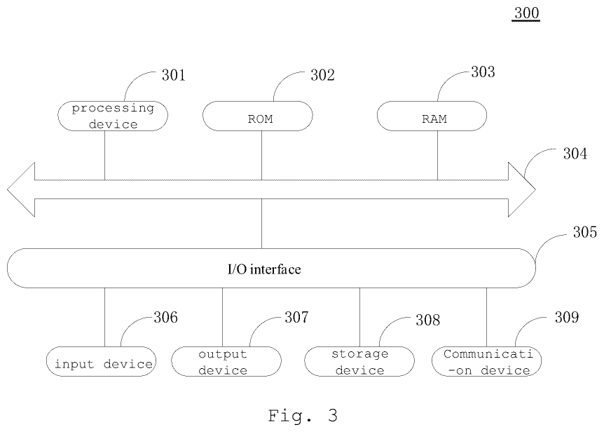

FIG. 3 is a schematic structural diagram of an electronic device provided by embodiments of the present disclosure. Referring to FIG. 3, a schematic structural diagram of an electronic device 500 suitable for implementing the embodiments of the present disclosure is shown. The electronic device 300 of the embodiments of the present disclosure may include, but not limited to, a mobile terminal such as a mobile phone, a notebook computer, a digital broadcast receiver, a PDA (Personal Digital Assistant), a PAD (tablet computer), a PMP (Portable Multimedia Player), an on-board terminal (such as an on-board navigation terminal), or a wearable electronic device, and a fixed terminal such as a digital TV, a desktop computer, or a smart-home device. The electronic device shown in FIG. 3 is merely an example and should not impose any limitation on the function and scope of the embodiments of the present disclosure.

As shown in FIG. 3, the electronic device 300 may include a processing device (e.g., a central processing unit, a graphics processor) 301, which may perform various appropriate actions and processes to implement the method of the embodiments of the present disclosure according to a program stored in Read Only Memory (ROM) 302 or a program loaded from storage device 308 into Random Access Memory (RAM) 303. In RAM 303, various programs and data required for the operations of the electronic device 300 are also stored. Processing device 301, ROM 302 and RAM 303 are connected to each other through bus 304. An input/output (I/O) interface 305 is also connected to the bus 304.

Generally, the following devices can be connected to I/O interface 305: input devices 306 including, for example, a touch screen, a touch pad, a keyboard, a mouse, a camera, a microphone, an accelerometer, a gyroscope, etc; output devices 307 including a liquid crystal display (LCD), a speaker, a vibrator, etc.; a storage device 308 such as a magnetic tape, a hard disk, etc; and a communication device 309. The communication device 309 enables the electronic device 300 to communicate in a wireless or wired manner with other devices to exchange data. Although FIG. 3 shows the electronic device 300 with various components, it should be understood that it is not required to implement or have all of these components. Alternatively, more or fewer components can be implemented or provided.

In particular, according to embodiments of the present disclosure, the processes described above with reference to the flowchart can be implemented as a computer software program. For example, embodiments of the present disclosure include a computer program product, which includes a computer program carried on a non-transitory computer readable medium, and containing program code for executing the method shown in the flowchart to implement the above method. In such an embodiment, the computer program may be downloaded and installed from the network through the communication device 309, or installed from the storage device 308, or from the ROM 302. When the computer program is executed by the processing device 301, the above functions defined in the method of the embodiments of the present disclosure are performed.

It should be noted that the computer readable medium in the present disclosure may be a computer readable signal medium or a computer readable storage medium, or any combination of thereof. The computer readable storage medium can be, for example, but not limited to, an electronic, magnetic, optical, electromagnetic, infrared, or semiconductor system, apparatus, or device, or any combination of the above. More specific examples of the computer readable storage medium may include, but are not limited to: electrical connection with one or more wires, portable computer disk, hard disk, random access memory (RAM), read only memory (ROM), erasable programmable read only memory (EPROM or flash), fiber optics, portable compact disk Read only memory (CD-ROM), optical storage device, magnetic storage device, or any suitable combination of the foregoing. In the present disclosure, a computer readable storage medium can be any tangible medium that can contain or store a program, which can be used by or in connection with an instruction execution system, apparatus or device. In the present disclosure, a computer readable signal medium may include a data signal that is propagated in the baseband or as part of a carrier, carrying computer readable program code. Such propagated data signals can take a variety of forms including, but not limited to, electromagnetic optical signals, or any suitable combination of the foregoing. The computer readable signal medium can also be any computer readable medium other than a computer readable storage medium, which can transmit, propagate, or transport a program for use by or in connection with the instruction execution system, apparatus, or device. Program code embodied on a computer readable medium can be transmitted by any suitable medium, including but not limited to wire, fiber optic cable, RF (radio frequency), etc., or any suitable combination of the foregoing.

In some embodiments, a client and a server can communicate using any currently known or future developed network protocol such as HTTP (HyperText Transfer Protocol), and can be interconnected by any form or medium of digital data communication, e.g., a communication network. Examples of communication networks include a local area network (“LAN”) and a wide area network (“WAN”), the Internet, and end-to-end networks (for example, ad hoc end-to-end networks), as well as any currently known or future developed networks.

The above computer readable medium may be included in the electronic device described above; or it may exist alone without being assembled into the electronic device.

The computer readable medium carries one or more programs that, when executed by the electronic device, cause the electronic device to perform steps of:
in response to receiving a first color adjustment instruction, processing a preset image based on a first color adjustment algorithm matching the first color adjustment instruction to obtain a first image, wherein mapped color values obtained from the preset image based on input color values are the same as the input color values; mapping color values in the first image to an original image to be processed in such a way that the original image presents a color effect that matches the first color adjustment instruction, the total number of pixel points in the preset image being less than the total number of pixel points in the original image.

Optionally, when the electronic device performs the above one or more programs, the electronic device may also perform other steps in the above embodiments.

The computer program code for executing operations of the present disclosure may be complied by any combination of one or more program design languages, the program design languages including object-oriented program design languages, such as Java, Smalltalk, C++, etc, as well as conventional procedural program design languages, such as “C” program design language or similar program design language. A program code may be completely or partly executed on a user computer, or executed as an independent software package, partly executed on the user computer and partly executed on a remote computer, or completely executed on a remote computer or server. In the circumstances involving a remote computer, the remote computer may be connected to the user computer through various kinds of networks, including local area network (LAN) or wide area network (WAN), or connected to external computer (for example using an internet service provider via Internet).

The flowcharts and block diagrams in the different depicted embodiments illustrate the architecture, functionality, and operation of some possible implementations of apparatus, methods and computer program products. In this regard, each block in the flowchart or block diagrams may represent a module, segment, or portion of code, which comprises one or more executable instructions for implementing the specified function or functions. It should also be noted that, in some alternative implementations, the functions noted in the block may occur out of the order noted in the drawings. For example, two blocks shown in succession may be executed substantially concurrently, or the blocks may sometimes be executed in the reversed order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The units involved in the embodiments described in the present disclosure can be implemented in software or hardware. Wherein, the names of the units do not constitute a limitation on the units themselves under certain circumstances.

The functions described above may be performed at least in part by one or more hardware logic components. For example, without limitation, exemplary types of hardware logic components that can be used include: Field Programmable Gate Array (FPGA), Application Specific Integrated Circuit (ASIC), Application Specific Standard Product (ASSP), System on Chip (SOC), Complex Programmable Logic Device (CPLD), etc.

In the context of the present disclosure, a machine-readable medium may be a tangible medium, which may contain or store a program for use by or in connection with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of thereof. More specific examples of the machine-readable storage medium may include electrical connection based on one or more wires, portable computer disk, hard disk, random access memory (RAM), read only memory (ROM), erasable programmable read only memory (EPROM or flash), fiber optics, portable compact disk Read only memory (CD-ROM), optical storage device, magnetic storage device, or any suitable combination of the foregoing.

According to one or more embodiments of the present disclosure, the present disclosure provides an image processing method, comprising: in response to receiving a first color adjustment instruction, processing a preset image based on a first color adjustment algorithm matching the first color adjustment instruction to obtain a first image, wherein mapped color values obtained from the preset image based on input color values are the same as the input color values; mapping color values in the first image to an original image to be processed in such a way that the original image presents a color effect that matches the first color adjustment instruction, the total number of pixel points in the preset image being less than the total number of pixel points in the original image.

According to one or more embodiments of the present disclosure, in the image processing method provided by this disclosure, prior to mapping color values in the first image to the original image to be processed, the method optionally further comprises: in response to receiving a second color adjustment instruction, processing the first image based on a second color adjustment algorithm matching the second color adjustment instruction to obtain a second image; mapping color values in the first image to the original image to be processed comprises: mapping color values in the second image to the original image in such a way that the original image presents color effects that match the first color adjustment instruction and the second color adjustment instruction, respectively.

According to one or more embodiments of the present disclosure, in the image processing method provided by the present disclosure, the preset image optionally comprises a color lookup table (LUT).

According to one or more embodiments of the present disclosure, in the image processing method provided by this disclosure, mapping color values in the first image to the original image to be processed optionally comprises: based on the color value of each pixel point in the original image, determining a mapped coordinate of the pixel point in the first image; determining a mapped color value of each pixel point based on the mapped coordinate of the pixel point in the first image; for each pixel point in the original image, replacing the color value of the current pixel point with the mapped color value of the current pixel point.

According to one or more embodiments of the present disclosure, in the image processing method provided by this disclosure, based on the color value of each pixel point in the original image, determining a mapped coordinate of the pixel point in the first image optionally comprises: based on the color value of a current pixel point, determining a first mapped coordinate of the pixel point in the first image using a first conversion rule, the current pixel point being any pixel point in the original image.

According to one or more embodiments of the present disclosure, in the image processing method provided by this disclosure, determining a mapped color value of each pixel point based on the mapped coordinate of the pixel point in the first image optionally comprises: in a case where there is a pixel point at the first mapped coordinate in the first image, determining the color value of the pixel point at the first mapped coordinate in the first image as the mapped color value of the current pixel point; in a case where there is no pixel point at the first mapped coordinate in the first image, determining the mapped color value of the current pixel point by interpolation.

According to one or more embodiments of the present disclosure, in the image processing method provided by this disclosure, determining the mapped color value of the current pixel point by interpolation optionally comprises: determining a second mapped coordinate of the current pixel point in the first image based on the color value of the current pixel point using a second conversion rule; determining a first color value corresponding to the first mapped coordinate and a second color value corresponding to the second mapped coordinate respectively; determining a mapped color value of the current pixel point based on the first color value and the second color value.

According to one or more embodiments of the present disclosure, in the image processing method provided by this disclosure, determining the mapped color value of the current pixel point based on the first color value and the second color value optionally comprises: taking a weighted sum of the first color value and the second color value to obtain the mapped color value of the current pixel point.

According to one or more embodiments of the present disclosure, the present disclosure provides an image processing apparatus, comprising: a first processing module configured to, in response to receiving a first color adjustment instruction, process a preset image based on a first color adjustment algorithm matching the first color adjustment instruction to obtain a first image, wherein mapped color values obtained from the preset image based on input color values are the same as the input color values; a second processing module configured to map color values in the first image to an original image to be processed in such a way that the original image presents a color effect that matches the first color adjustment instruction, the total number of pixel points in the preset image being less than the total number of pixel points in the original image.

According to one or more embodiments of the present disclosure, the present disclosure provides an electronic device, comprising:
one or more processors;
a memory for storing one or more programs that,
when executed by the one or more processors, cause the one or more processors to implement the image processing method provided by any embodiment of the present disclosure.

According to one or more embodiments of the present disclosure, the present disclosure provides a computer-readable storage medium stored thereon a computer program that, when executed by a processor, implements the image processing method provided by any embodiments of the present disclosure.

Embodiments of the present disclosure further provides a computer program product comprising computer programs or instructions that, when executed by a processor, implement the above image processing method.

The above description is only preferred embodiments of the present disclosure and an explanation of the applied technical principles. Those skilled in the art should understand that the scope of disclosure involved in this disclosure is not limited to the technical solutions formed by the specific combination of the above technical features, and should also cover other technical solutions formed by any combination of the above technical features or their equivalent features without departing from the disclosed concept, for example, technical solutions formed by replacing the above features with technical features having similar functions to (but not limited to) those disclosed in the present disclosure.

In addition, although the operations are depicted in a specific order, this should not be understood as requiring these operations to be performed in the specific order shown or performed in a sequential order. Under certain circumstances, multitasking and parallel processing may be advantageous. Likewise, although several specific implementation details are included in the above discussion, these should not be construed as limiting the scope of the present disclosure. Certain features that are described in the context of separate embodiments can also be implemented in combination in a single embodiment. Conversely, various features described in the context of a single embodiment can also be implemented in multiple embodiments individually or in any suitable subcombination.

Although the subject matter has been described in language specific to structural features and/or logical actions of the method, it should be understood that the subject matter defined in the appended claims is not necessarily limited to the specific features or actions described above. On the contrary, the specific features and actions described above are merely exemplary forms of implementing the claims.

1. An image processing method, comprising:
in response to receiving a first color adjustment instruction, processing a preset image based on a first color adjustment algorithm matching the first color adjustment instruction to obtain a first image, wherein mapped color values obtained from the preset image based on input color values are the same as the input color values; and
mapping color values in the first image to an original image to be processed to obtain a mapped original image in such a way that the mapped original image presents a color effect that matches the first color adjustment instruction, the total number of pixel points in the preset image being less than the total number of pixel points in the original image.

2. The method according to claim 1, wherein prior to mapping the color values in the first image to the original image to be processed to obtain the mapped original image, the method further comprises:
in response to receiving a second color adjustment instruction, processing the first image based on a second color adjustment algorithm matching the second color adjustment instruction to obtain a second image; and
mapping the color values in the first image to the original image to be processed to obtain the mapped original image comprises:
mapping color values in the second image to the original to obtain the mapped original image in such a way that the mapped original image presents color effects that match the first color adjustment instruction and the second color adjustment instruction, respectively.

3. The method according to claim 1, wherein the preset image comprises a color lookup table (LUT), wherein the mapped color values are obtained from the present image bases on the input color values via the following operations:
determining a position on the LUT corresponding to an input color value; and
using a color value at the position on the LUT as a mapped color value.

4. The method according to claim 3, wherein mapping color values in the first image to the original image to be processed to obtain the mapped original image comprises:
based on a color value of each pixel point in the original image, determining a mapped coordinate of the pixel point in the first image;
determining a mapped color value of each pixel point based on the mapped coordinate of the pixel point in the first image; and
for each pixel point in the original image, replacing the color value of a current pixel point in the original image with the mapped color value of the current pixel point to obtain the mapped original image, the current pixel point being any pixel point in the original image.

5. The method according to claim 4, wherein based on the color value of each pixel point in the original image, determining the mapped coordinate of the pixel point in the first image comprises:
based on the color value of the current pixel point, determining a first mapped coordinate of the current pixel point in the first image using a first conversion rule.

6. The method according to claim 5, wherein determining a mapped color value of each pixel point based on the mapped coordinate of the pixel point in the first image comprises:
in response to determining that there is a pixel point at the first mapped coordinate in the first image, determining the color value of the pixel point at the first mapped coordinate in the first image as the mapped color value of the current pixel point.

7. The method according to claim 6, wherein determining the mapped color value of the current pixel point by interpolation comprises:
determining a second mapped coordinate of the current pixel point in the first image based on the color value of the current pixel point using a second conversion rule;
determining a first color value corresponding to the first mapped coordinate and a second color value corresponding to the second mapped coordinate respectively; and
determining a mapped color value of the current pixel point based on the first color value and the second color value.

8. The method according to claim 7, wherein determining a mapped color value of the current pixel point based on the first color value and the second color value comprises:
taking a weighted sum of the first color value and the second color value to obtain the mapped color value of the current pixel point.

9. (canceled)

10. An electronic device, comprising:
one or more processors;
a storage device for storing one or more programs that, when executed by the one or more processors, cause the one or more processors to implement the method comprising:
in response to receiving a first color adjustment instruction, processing a preset image based on a first color adjustment algorithm matching the first color adjustment instruction to obtain a first image, wherein mapped color values obtained from the preset image based on input color values are the same as the input color values; and
mapping color values in the first image to an original image to be processed to obtain a mapped original image in such a way that the mapped original image presents a color effect that matches the first color adjustment instruction, the total number of pixel points in the preset image being less than the total number of pixel points in the original image.

11. A non-transitory computer-readable storage medium stored thereon a computer program that, when executed by a processor, implements the method comprising:
in response to receiving a first color adjustment instruction, processing a preset image based on a first color adjustment algorithm matching the first color adjustment instruction to obtain a first image, wherein mapped color values obtained from the preset image based on input color values are the same as the input color values; and
mapping color values in the first image to an original image to be processed to obtain a mapped original image in such a way that the mapped original image presents a color effect that matches the first color adjustment instruction, the total number of pixel points in the preset image being less than the total number of pixel points in the original image.

12-13. (canceled)

14. The method according to claim 5, wherein determining a mapped color value of each pixel point based on the mapped coordinate of the pixel point in the first image comprises:
in response to determining that there is no pixel point at the first mapped coordinate in the first image, determining the mapped color value of the current pixel point by interpolation.

15. The electronic device according to claim 10, wherein prior to mapping the color values in the first image to the original image to be processed to obtain the mapped original image, the method further comprises:
in response to receiving a second color adjustment instruction, processing the first image based on a second color adjustment algorithm matching the second color adjustment instruction to obtain a second image; and
mapping the color values in the first image to the original image to be processed to obtain the mapped original image comprises:
mapping color values in the second image to the original image to obtain the mapped original image in such a way that the mapped original image presents color effects that match the first color adjustment instruction and the second color adjustment instruction, respectively.

16. The electronic device according to claim 10, wherein the preset image comprises a color lookup table (LUT), and wherein the mapped color values are obtained from the preset image based on the input color values via the following operations:
determining a position on the LUT corresponding to an input color value; and
using a color value at the position on the LUT as a mapped color value.

17. The electronic device according to claim 16, wherein mapping color values in the first image to the original image to be processed to obtain the mapped original image comprises:
based on a color value of each pixel point in the original image, determining a mapped coordinate of the pixel point in the first image;
determining a mapped color value of each pixel point based on the mapped coordinate of the pixel point in the first image; and
for each pixel point in the original image, replacing the color value of a current pixel point in the original image with the mapped color value of the current pixel point to obtain the mapped original image, the current pixel point being any pixel point in the original image.

18. The electronic device according to claim 17, wherein based on the color value of each pixel point in the original image, determining the mapped coordinate of the pixel point in the first image comprises:
based on the color value of the current pixel point, determining a first mapped coordinate of the current pixel point in the first image using a first conversion rule.

19. The electronic device according to claim 18, wherein determining a mapped color value of each pixel point based on the mapped coordinate of the pixel point in the first image comprises:
in response to determining that there is a pixel point at the first mapped coordinate in the first image, determining the color value of the pixel point at the first mapped coordinate in the first image as the mapped color value of the current pixel point.

20. The non-transitory computer-readable storage medium according to claim 11, wherein prior to mapping the color values in the first image to the original image to be processed to obtain the mapped original image, the method further comprises:
in response to receiving a second color adjustment instruction, processing the first image based on a second color adjustment algorithm matching the second color adjustment instruction to obtain a second image; and
mapping the color values in the first image to the original image to be processed to obtain the mapped original image comprises:
mapping color values in the second image to the original image to obtain the mapped original image in such a way that the mapped original image presents color effects that match the first color adjustment instruction and the second color adjustment instruction, respectively.

21. The non-transitory computer-readable storage medium according to claim 11, wherein the preset image comprises a color lookup table (LUT), and wherein the mapped color values are obtained from the preset image based on the input color values via the following operations:
determining a position on the LUT corresponding to an input color value; and
using a color value at the position on the LUT as a mapped color value.

22. The non-transitory computer-readable storage medium according to claim 21, wherein mapping color values in the first image to the original image to be processed to obtain the mapped original image comprises:
based on a color value of each pixel point in the original image, determining a mapped coordinate of the pixel point in the first image;
determining a mapped color value of each pixel point based on the mapped coordinate of the pixel point in the first image; and
for each pixel point in the original image, replacing the color value of a current pixel point in the original image with the mapped color value of the current pixel point to obtain the mapped original image, the current pixel point being any pixel point in the original image.

23. The non-transitory computer-readable storage medium according to claim 22, wherein based on the color value of each pixel point in the original image, determining the mapped coordinate of the pixel point in the first image comprises:
based on the color value of the current pixel point, determining a first mapped coordinate of the current pixel point in the first image using a first conversion rule.
